(19) United States
(12) Patent Application Publication
(10) Pub. No.: US 2013/0054423 A1
(43) Pub. Date: Feb. 28, 2013

(54) METHOD AND SYSTEM FOR SELLING GOODS ONLINE IN AFFILIATION WITH E-TAILER

(71) Applicant: Sungmin HWANG, Guri-si (KR)

(72) Inventor: Sungmin HWANG, Guri-si (KR)

(21) Appl. No.: 13/281,866

(22) Filed: Oct. 26, 2011

(30) Foreign Application Priority Data
Aug. 24, 2011 (KR) 10-2011-0084766

(51) Int. Cl. G06Q 30/06

(52) U.S. Cl. 705/27.1

(57) ABSTRACT

A method and system for selling goods in affiliation with an e-tailer are disclosed, in which a first server that operates an online sales service receives product information from a second server of the e-tailer, updates a site for providing the online sales service using the received product information, receives information about a product selected from the site and information about an e-voucher recipient from a terminal of a purchaser, requests payment information to the terminal of the purchaser, receives the payment information from the terminal of the purchaser, and transmits an e-voucher including an authentication code to a terminal of the e-voucher recipient using the information about the e-voucher recipient, upon completion of payment based on the payment information, the authentication code being used for exchanging the e-voucher for the selected product.

This application claims priority to Korean Patent Application No. 10-2011-0084766, filed on Aug. 24, 2011, which is hereby incorporated by reference as if fully set forth herein.

### BACKGROUND OF THE INVENTION

1. Field of the Invention

The present invention relates to a method and system for selling goods online in affiliation with an e-tailer, and more particularly, to a method and system for selling goods online in affiliation with an e-tailer that runs its own online shopping site, so that the e-tailer can sell goods according to the online selling method and system of the present invention as well as through its online shopping site, a purchaser can send a purchased product in the form of an e-voucher to an e-voucher recipient, and the e-voucher recipient can receive the product at his or her own discretion.

2. Discussion of the Related Art

Along with the development of information and communication technology, most of offline transactions have also been made online. Online transactions include, for example, orders by phone, home shopping, Internet shopping, etc.

Among them, the market of Internet shopping is prospering and increasing impressively. At present, a variety of goods are sold in Internet shopping malls. A business that sells its products by e-commerce is usually called an e-tailer. An e-tailer sells products on its online site.

When a user searches an Internet portal site for his or her intended product, e-tailer's sites matching the search are listed. The user purchases the product by accessing a site run by a selected e-tailer linked to the portal site, rather than directly on the portable site.

The same thing takes place on a meta site that collects information about a plurality of online shopping sites and provides the collected information.

Accordingly, on the part of a customer, it is inconvenient to eventually access the site of an e-tailer that deals with an intended product.

Meanwhile, online shopping sites can deliver a product purchased by a customer as a gift to a designated recipient instead of the customer. This gift marketing has recently been boosted.

In online commerce, conventionally, the gift recipient is not given options to get the product to be delivered to a specific location or to visit an offline store and pick up the product from the offline store on his or her own. Therefore, delivery or offline pick-up is at the discretion of the purchaser.

If the product is given as a coupon to the recipient, the recipient may not have time enough to visit an offline store until expiration of the coupon. On the other hand, the product may be delivered against the will of the recipient or to an unintended location.

### SUMMARY OF THE INVENTION

Accordingly, the present invention is directed to a method and system for selling goods online in affiliation with an e-tailer that substantially obviate one or more problems due to limitations and disadvantages of the related art.

An object of the present invention is to provide a method and system for selling goods online in affiliation with an e-tailer, in which product information is received from the e-tailer and a product sales service is provided to a customer based on the product information, separately from an online shopping site run by the e-tailer.

Another object of the present invention is to provide a method and system for selling goods online in affiliation with an e-tailer, in which a customer can give a purchased product as a gift in the form of an e-voucher to a gift recipient and thus the e-voucher recipient can conveniently make a choice between exchanging the e-voucher for a product and getting a product to be delivered to an intended location according to his or her own needs.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for selling goods online in affiliation with an e-tailer includes receiving product information from a second server of the e-tailer by a first server that operates an online sales service, updating a site for providing the online sales service using the received product information by the first server, receiving information about a product selected from the site and information about an e-voucher recipient from a terminal of a purchaser by the first server, requesting payment information to the terminal of the purchaser and receiving the payment information from the terminal of the purchaser by the first server, and transmitting an e-voucher including an authentication code to a terminal of the e-voucher recipient using the information about the e-voucher recipient by the first server, upon completion of payment based on the payment information, the authentication code being used for exchanging the e-voucher for the selected product.

The terminal of the purchaser may access the site by executing an application for the online sales service installed on the terminal of the purchaser.

The information about the e-voucher recipient may include at least one of a phone number, an e-mail address, or a Social Networking Service (SNS) IDentifier (ID) of the e-voucher recipient.

When the information about the e-voucher recipient includes a phone number of the terminal of the e-voucher recipient, an application for the online sales service is installed on the terminal of the e-voucher recipient, and the e-voucher recipient has subscribed to the online sales service, the e-voucher transmitted by the first server may be provided to the e-voucher recipient through the application.

The e-voucher may include a delivery request menu for inputting delivery destination information for use in delivery of the selected product.

The method may further include receiving delivery destination information input in the delivery request menu from the terminal of the e-voucher recipient by the first server, and transmitting the delivery destination information to the second server by the first server.

The method may further include storing state information about the e-voucher by the first server.

The state information about the e-voucher may include product information, authentication code information, used or unused indication information, refund information, and valid duration information about the e-voucher.

Upon receipt of an authentication request signal including the authentication code of the e-voucher from an offline store terminal, the first server may authenticate the e-voucher based on the state information about the e-voucher, transmit an authentication result to the offline store terminal, and update the state information about the e-voucher with the authentication result.

The first server may compare a current time with a valid duration of the e-voucher using the state information about the e-voucher, store virtual money corresponding to the e-voucher to a virtual money storage of an account opened when the purchaser subscribed to the online sales service, when determining that the e-voucher has expired, and update the state information about the e-voucher.

Upon receipt of a refund request including the authentication code of the e-voucher from the terminal of the e-voucher recipient, the first server may authenticate the e-voucher based on the state information about the e-voucher, store virtual money corresponding to the e-voucher to a virtual money storage of an account opened when the purchaser subscribed to the online sales service, when determining that the e-voucher is valid, and update the state information about the e-voucher.

Upon receipt of a refund request including the authentication code of the e-voucher from the second server, the first server may authenticate the e-voucher based on the state information about the e-voucher, store virtual money corresponding to the e-voucher to a virtual money storage of an account opened when the purchaser subscribed to the online sales service, if determining that the e-voucher is valid, and update the state information about the e-voucher.

In another aspect of the present invention, a method for selling goods online in affiliation with an e-tailer includes requesting information about an e-voucher recipient to a terminal of a purchaser by a first server that operates an online sales service, when the terminal of the purchaser executes a gift menu linked to an online shopping site of a second server of the e-tailer, receiving the information about the e-voucher recipient from the terminal of the purchaser by the first server, requesting payment information to the terminal of the purchaser and receiving the payment information from the terminal of the purchaser by the first server, and transmitting an e-voucher including an authentication code to a terminal of the e-voucher recipient using the information about the e-voucher recipient by the first server, upon completion of payment based on the payment information, the authentication code being used for exchanging the e-voucher for the selected product.

The terminal of the purchaser may access the site by executing an application for the online sales service installed on the terminal of the purchaser.

The information about the e-voucher recipient may include at least one of a phone number, an e-mail address, or an SNS ID of the e-voucher recipient.

When the information about the e-voucher recipient includes a phone number of the terminal of the e-voucher recipient, an application for the online sales service is installed on the terminal of the e-voucher recipient, and the e-voucher recipient has subscribed to the online sales service, the e-voucher transmitted by the first server may be provided to the e-voucher recipient through the application.

The e-voucher may include a delivery request menu for inputting delivery destination information for use in delivery of the selected product.

The method may further include receiving delivery destination information input in the delivery request menu from the terminal of the e-voucher recipient by the first server, and transmitting the delivery destination information to the second server by the first server.

The method may further include storing state information about the e-voucher by the first server.

The state information about the e-voucher may include product information, authentication code information, used or unused indication information, refund information, and valid duration information about the e-voucher.

Upon receipt of an authentication request signal including the authentication code of the e-voucher from an offline store terminal, the first server may authenticate the e-voucher based on the state information about the e-voucher, transmit an authentication result to the offline store terminal, and update the state information about the e-voucher with the authentication result.

The first server may compare a current time with a valid duration of the e-voucher using the state information about the e-voucher, store virtual money corresponding to the e-voucher to a virtual money storage of an account opened when the purchaser subscribed to the online sales service, when determining that the e-voucher has expired, and update the state information about the e-voucher.

Upon receipt of a refund request including the authentication code of the e-voucher from the terminal of the e-voucher recipient, the first server may authenticate the e-voucher based on the state information about the e-voucher, add virtual money corresponding to the e-voucher to a virtual money storage of an account opened when the purchaser subscribed to the online sales service, when determining that the e-voucher is valid, and update the state information about the e-voucher.

Upon receipt of a refund request including the authentication code of the e-voucher from the second server, the first server may authenticate the e-voucher based on the state information about the e-voucher, store virtual money corresponding to the e-voucher to a virtual money storage of an account opened when the purchaser subscribed to the online sales service, when determining that the e-voucher is valid, and update the state information about the e-voucher.

In another aspect of the present invention, a system for selling goods online in affiliation with an e-tailer includes a first server that operates an online sales service and a second server of the e-tailer. The first server receives product information from the second server and updates a site for providing the online sales service using the received product information. Upon receipt of information about a product selected from the site and information about an e-voucher recipient from a terminal of a purchaser, the first server requests payment information to the terminal of the purchaser and receives the payment information from the terminal of the purchaser. Upon completion of payment based on the payment information, the first server transmits an e-voucher including an authentication code to a terminal of the e-voucher recipient using the information about the e-voucher recipient, the authentication code being used for exchanging the e-voucher for the selected product.

The terminal of the purchaser may access the site by executing an application for the online sales service installed on the terminal of the purchaser.

The information about the e-voucher recipient may include at least one of a phone number, an e-mail address, or an SNS ID of the e-voucher recipient.

When the information about the e-voucher recipient includes a phone number of the terminal of the e-voucher recipient, an application for the online sales service is installed on the terminal of the e-voucher recipient, and the e-voucher recipient has subscribed to the online sales service, the e-voucher transmitted by the first server may be provided to the e-voucher recipient through the application.

The e-voucher may include a delivery request menu for inputting delivery destination information for use in delivery of the selected product.

Upon receipt of delivery destination information inputted through the delivery request menu from the terminal of the e-voucher recipient, the first server may transmit the delivery destination information to the second server.

The first server may include a state information storage for storing state information about the e-voucher.

The state information about the e-voucher may include product information, authentication code information, used or unused indication information, refund information, and valid duration information about the e-voucher.

Upon receipt of an authentication request signal including the authentication code of the e-voucher from an offline store terminal, the first server may authenticate the e-voucher based on the state information about the e-voucher, transmit an authentication result to the offline store terminal, and update the state information about the e-voucher with the authentication result.

The first server may compare a current time with a valid duration of the e-voucher using the state information about the e-voucher, store virtual money corresponding to the e-voucher to a virtual money storage of an account opened when the purchaser subscribed to the online sales service, when determining that the e-voucher has expired, and update the state information about the e-voucher.

Upon receipt of a refund request including the authentication code of the e-voucher from the terminal of the e-voucher recipient, the first server may authenticate the e-voucher based on the state information about the e-voucher, add virtual money corresponding to the e-voucher to a virtual money storage of an account opened when the purchaser subscribed to the online sales service, when determining that the e-voucher is valid, and update the state information about the e-voucher.

Upon receipt of a refund request including the authentication code of the e-voucher from the second server, the first server may authenticate the e-voucher based on the state information about the e-voucher, store virtual money corresponding to the e-voucher to a virtual money storage of an account opened when the purchaser subscribed to the online sales service, when determining that the e-voucher is valid, and update the state information about the e-voucher.

In a further aspect of the present invention, a system for selling goods online in affiliation with an e-tailer includes a first server that operates an online sales service and a second server of the e-tailer. When a terminal of a purchaser executes a gift menu linked to an online shopping site of the second server, the first server requests information about an e-voucher recipient to the terminal of the purchaser and receives the information about the e-voucher recipient from the terminal of the purchaser. The first server requests payment information to the terminal of the purchaser and receives the payment information from the terminal of the purchaser. Upon completion of payment based on the payment information, the first server transmits an e-voucher including an authentication code to a terminal of the e-voucher recipient using the information about the e-voucher recipient by the first server, the authentication code being used for exchanging the e-voucher for the selected product.

The terminal of the purchaser may access the site by executing an application for the online sales service installed on the terminal of the purchaser.

The information about the e-voucher recipient may include at least one of a phone number, an e-mail address, or an SNS ID of the e-voucher recipient.

When the information about the e-voucher recipient includes a phone number of the terminal of the e-voucher recipient, an application for the online sales service is installed on the terminal of the e-voucher recipient, and the e-voucher recipient has subscribed to the online sales service, the e-voucher transmitted by the first server may be provided to the e-voucher recipient through the application.

The e-voucher may include a delivery request menu for inputting delivery destination information for use in delivery of the selected product.

Upon receipt of delivery destination information input in the delivery request menu from the terminal of the e-voucher recipient, the first server may transmit the delivery destination information to the second server.

The first server may include a state information storage for storing state information about the e-voucher.

The state information about the e-voucher may include product information, authentication code information, used or unused indication information, refund information, and valid duration information about the e-voucher.

Upon receipt of an authentication request signal including the authentication code of the e-voucher from an offline store terminal, the first server may authenticate the e-voucher based on the state information about the e-voucher, transmit an authentication result to the offline store terminal, and update the state information about the e-voucher with the authentication result.

The first server may compare a current time with a valid duration of the e-voucher using the state information about the e-voucher, store virtual money corresponding to the e-voucher to a virtual money storage of an account opened when the purchaser subscribed to the online sales service, when determining that the e-voucher has expired, and update the state information about the e-voucher.

Upon receipt of a refund request including the authentication code of the e-voucher from the terminal of the e-voucher recipient, the first server may authenticate the e-voucher based on the state information about the e-voucher, store virtual money corresponding to the e-voucher to a virtual money storage of an account opened when the purchaser subscribed to the online sales service, when determining that the e-voucher is valid, and update the state information about the e-voucher.

Upon receipt of a refund request including the authentication code of the e-voucher from the second server, the first server may authenticate the e-voucher based on the state information about the e-voucher, store virtual money corresponding to the e-voucher to a virtual money storage of an account opened when the purchaser subscribed to the online sales service, when determining that the e-voucher is valid, and update the state information about the e-voucher.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates the configuration of an online sales system for selling goods online in affiliation with an e-tailer according to the present invention;

FIG. 2 is a flowchart illustrating a method for selling goods online in affiliation with an e-tailer according to an embodiment of the present invention;

FIG. 3 illustrates an exemplary e-voucher according to the embodiment of the present invention;

FIG. 4 illustrates an exemplary screen for inputting a delivery destination in an e-voucher;

FIG. 5 is a flowchart illustrating a method for selling goods online in affiliation with an e-tailer according to an alternative embodiment of the present invention;

FIG. 6 illustrates an exemplary online shopping site run by a second server according to the alternative embodiment of the present invention;

FIG. 7 is another flowchart illustrating the method for selling goods online in affiliation with an e-tailer according to the alternative embodiment of the present invention;

FIG. 8 illustrates a procedure from clicking on a “Gift” button to shipping of an e-voucher in the method for selling goods online in affiliation with an e-tailer according to the alternative embodiment of the present invention;

FIG. 9 illustrates a procedure from a purchaser's login to a recipient's receipt of a product in the method for selling goods online in affiliation with an e-tailer according to the alternative embodiment of the present invention;

FIG. 10 illustrates a refund procedure in the method for selling goods online in affiliation with an e-tailer according to the alternative embodiment of the present invention; and

FIG. 11 is a block diagram of a device applicable to a first server and a second server, for implementing the present invention.

### DETAILED DESCRIPTION OF THE INVENTION

The objectives and effects of the present invention and the technical configurations of the present invention to achieve them will be apparent with reference to embodiments of the present invention described in detail with the attached drawings. A detailed description of a generally known function and structure of the present invention will be avoided lest it should obscure the subject matter of the present invention. Although the terms used in the present invention are selected from generally known and used terms, taking into account the structures, roles, and functions of the present invention, they are subject to change depending on the intention of a user or an operator or practices.

It is to be clearly understood that the present invention may be implemented in various manners, not limited to embodiments as set forth herein. The embodiments of the present invention are provided only to render the disclosure of the present invention comprehensive and indicate the scope of the present invention to those skilled in the art. The present invention is defined only by the appended claims. Accordingly, the scope of the invention should be determined by the overall description of the specification.

Through the specification, when it is said that some part “includes” a specific element, this means that the part may further include other elements, not excluding them, unless otherwise mentioned. The term “-er(or)”, “module”, “unit” or “part” is used to signify a unit of performing at least one function or operation. The unit can be realized in hardware, software, or in combination of both.

Meanwhile, in the embodiments of the present invention, each component, function block, or device may be configured with one or more lower components and its electrical, electronic and mechanical functions can be implemented with various known devices or mechanical components such as an electronic circuit, an integrated circuit, an Application Specific Integrated Circuit (ASIC), etc. Each component may be separately configured or two or more components may be incorporated into a single component.

It will be understood that each block and combinations of blocks of the attached flowchart and/or block diagram illustrations may be implemented by computer program instructions. These computer program instructions may be loaded onto a processor of a general-purpose computer, a special-purpose computer, or other programmable data processing apparatus to produce a machine, such that the instructions, which execute via the processor of the computer or other programmable data processing apparatus, create means for implementing the functions specified in the flowchart and/or block diagram block or blocks. These computer program instructions may also be stored in a computer-usable or computer-readable memory that may direct a computer or other programmable data processing apparatus to function in a particular manner, such that the instructions stored in the computer-usable or computer-readable memory produce an article of manufacture including instructions that implement the function specified in the flowchart and/or block diagram block or blocks. The computer program instructions may also be loaded onto a computer or other programmable data processing apparatus to cause a series of operational steps to be performed on the computer or other programmable data processing apparatus to produce a computer implemented process such that the instructions that execute on the computer or other programmable data processing apparatus provide steps for implementing the functions specified in the flowchart and/or block diagram block or blocks.

Each block or step may represent a module, a segment, or a portion of code, which may comprise one or more executable instructions for implementing a specified logical function or functions. It should also be noted that in some alternative embodiments, the functions noted in the blocks or steps occur out of the order. For example, two block or steps shown in succession may, in fact, be executed substantially concurrently or the blocks or steps may be sometimes executed in the reverse order, depending on the functionality involved.

Now, methods for selling goods online in affiliation with an e-tailer according to embodiments of the present invention will be described in detail with reference to the attached drawings.

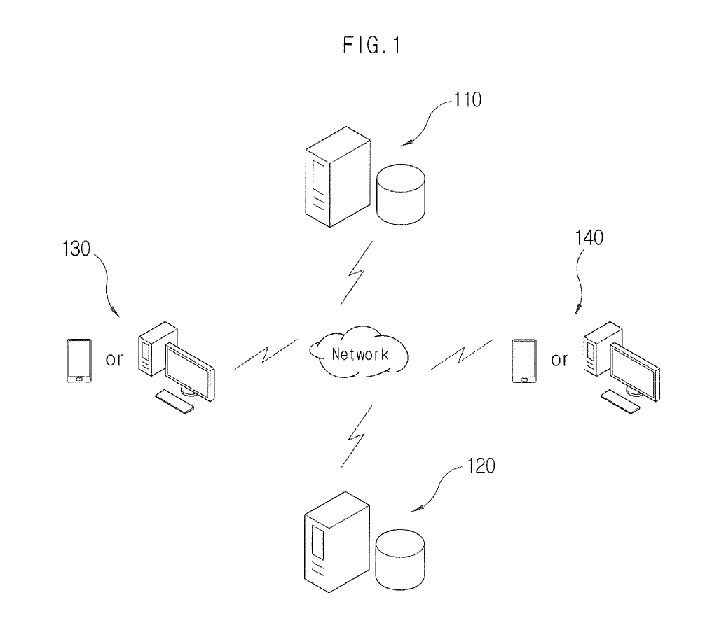

FIG. 1 illustrates the configuration of an online sales system for selling goods online in affiliation with an e-tailer according to the present invention.

Referring to FIG. 1, an online sales system according to the present invention includes a first server 110 for providing overall operation and management of its online sales service in affiliation with an e-tailer according to the present invention, a second server 120 of the e-tailer, for providing the e-tailer's own online sales service, a user terminal 130 of a purchaser, and a user terminal 140 of an e-voucher recipient.

The user terminals 130 and 140 may be any device that enables use of the online sales service of the present invention over a network, including mobile devices such as a smart pad and a smart phone and PCs such as a laptop and a desktop.

The first server 110, the second server 120, the user terminal 130 of the purchaser, and the user terminal 140 of the e-voucher recipient are connected to one another through a network. The network may include a wired or wireless network over which signals can be transmitted among the first server 110, the second server 120, and the user terminals 130 and 140.

According to the present invention, an e-tailer may be defined as an entity that provides an online sales service on its own online shopping site. The second server 120 functions to perform the online sales service in affiliation with an e-tailer according to the present invention in conjunction with the first server 110 as well as operates and manages the online sales service of the e-tailer.

Now an embodiment of the present invention for the online sales system will be described below.

### Embodiment 1

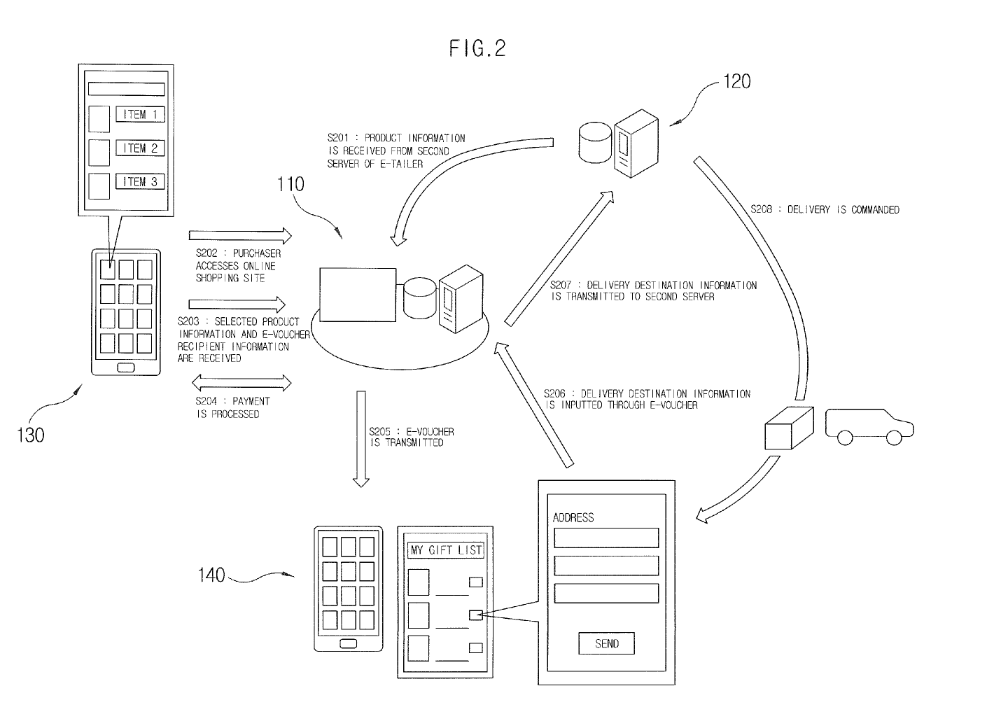

FIG. 2 is a flowchart illustrating a method for selling goods online in affiliation with an e-tailer according to an embodiment of the present invention.

Referring to FIG. 2, the first server 110 that runs an online shopping site receives product information from the second server 120 of the e-tailer (S201). The product information describes all or a part of products for sale on the online shopping site of the e-tailer. If the product information is about a part of the products for sale, the products described by the product information may be popular products or e-tailer-selected products. In addition, the product information may describe products that the e-tailer wants to sell as well as products for sale on the online shopping site of the e-tailer.

Besides on its own online shopping site, the e-tailer may also sell products on the online shopping site of the first server 110 by providing the product information to the first server 110. The product information may include product images, descriptions of products, the prices of the products, and images associated with the products. The product information may be transmitted from the second server 120 to the first server 110 in Application Programming Interface/eXtensible Markup Language (API/XML).

The first server 110 updates its online shopping site with the received product information in order to help site visitors to shop on the online shopping site.

The purchaser accesses the online shopping site of the first server 110 through the user terminal 130 (S202). If the user terminal 130 of the purchaser is a smart phone having an application for the online sales service of the first server 110 installed, the user terminal 130 may access the online shopping site of the first server 110 by executing the application. If the user terminal 130 is a PC, the user terminal 130 may access the online shopping site of the first server 110 using the address of the online shopping site of the first server 110.

Then the first server 110 receives information about a product selected from the online shopping site and information about the e-voucher recipient from the user terminal 130 of the purchaser (S203). More specifically, when the purchaser accesses the online shopping site of the first server 110 through the user terminal 130, selects a product from the online shopping site, and selects a Gift menu on the online shopping site, the first server 110 provides an input window for entering information about the e-voucher recipient. When the purchaser inputs information about the e-voucher recipient and selects sending the information about the e-voucher recipient on the user terminal 130, the user terminal 130 transmits information about the selected product and the information about the e-voucher recipient to the first server 110.

The first server 110 may further provide a menu for allowing the purchaser to add a message for the e-voucher recipient. When the purchaser inputs a message in the menu, the user terminal 130 may transmit the message to the first server 110 and thus the first server 110 may transmit an e-voucher together with the received message to the e-voucher recipient.

The information about the e-voucher recipient may include at least one of a phone number of the user terminal 140, and the name, an e-mail address, and a Social Networking Service (SNS) Identifier (ID) of the e-voucher recipient.

After receiving the product information and the e-voucher recipient information, the first server 110 requests payment to the user terminal 130 of the purchaser and upon receipt of payment information from the user terminal 130, the first server 110 performs a payment process (S204).

Upon completion of the payment process, the first server 110 transmits an e-voucher to the user terminal 140 of the e-voucher recipient based on the e-voucher recipient information (S205). The e-voucher is an electronic gift certificate that can be transmitted by e-mail, Short Message Service (SMS), or an application installed on a smart phone.

The first server 110 includes a state information storage for storing state information about the e-voucher. When the first server 110 transmits the e-voucher, the first server 110 generates and stores state information about the e-voucher. The state information about the e-voucher may include product information, authentication code information, used or unused indication information, refund information, and duration information, regarding the e-voucher.

The e-voucher recipient may print out the e-voucher and pick up the product in exchange for the e-voucher in an offline store, or may request delivery of the product to a desired location by signing up for delivery as described later.

In the case where the e-voucher recipient information includes the phone number of the user terminal 140 of the e-voucher recipient, an application for the online sales service is installed on the user terminal 140, and the e-voucher recipient has subscribed to the online sales service, the e-voucher is provided to the recipient by the application through the user terminal 140. For example, upon receipt of the e-voucher, the user terminal 140 pops up a message window and alerts the recipient to receipt of the e-voucher in the message window. Thus the e-voucher recipient may view the e-voucher through the application. On the other hand, if the application is not installed on the user terminal 140 or the recipient has not subscribed to the online sales service, the e-voucher may be provided to the recipient by SMS.

If the e-voucher recipient information includes the e-mail address or SNS ID of the e-voucher recipient, the e-voucher may be transmitted to the e-mail address or the SNS ID.

The e-voucher includes a delivery request menu. When the e-voucher recipient executes the delivery request menu, a menu for inputting a delivery address is provided. When the e-voucher recipient inputs a delivery address and requests sending the delivery address, the user terminal 140 transmits the delivery destination information to the first server 110 (S206).

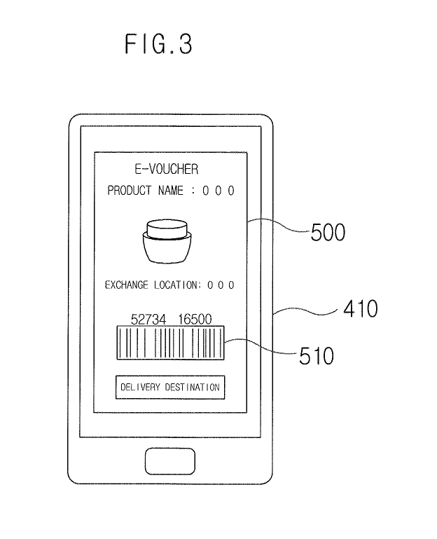

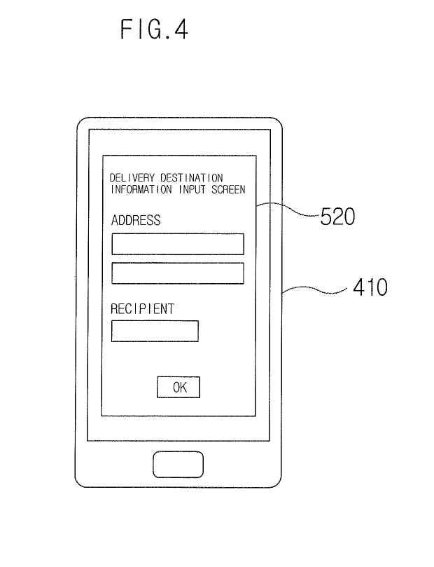

FIG. 3 illustrates an exemplary e-voucher in the method for selling goods online in affiliation with an e-tailer, illustrated in FIG. 2 and FIG. 4 illustrates an exemplary screen for inputting a delivery destination in an e-voucher.

The afore-described e-voucher may include a product name, a product image, information about an exchange location, an authentication code such as barcode digits, a barcode symbol, and a delivery destination input screen 520 on which the e-voucher recipient may input a delivery destination. For example, when the e-voucher recipient clicks on a delivery destination input menu (for instance, a square with ‘delivery destination’ written inside in FIG. 3) in an e-voucher 500 illustrated in FIG. 3, the delivery destination input screen 520 linked to the delivery destination input menu appears on a display as illustrated in FIG. 4.

In FIG. 3, reference numeral 510 denotes a barcode having the authentication code of the e-voucher 500. If the e-voucher recipient visits an offline store and wants to exchange the e-voucher for a product or a service, the offline store scans the barcode 510 using an offline store terminal, for instance, a barcode reader of a Point Of Sales (POS) system. Then the POS system transmits an authentication request signal including the authentication code to the first server 110 and the first server 110 transmits an authentication result to the POS system after performing an authentication procedure based on the state information about the e-voucher. The POS system may display the product information, the e-voucher, information indicating whether the e-voucher has been used, and the valid duration of the e-voucher on a display in real time according to the authentication result. The first server 110 updates the state information about the e-voucher based on the authentication result. That is, the first server 110 changes the used or unused indication information included in the state information about the e-voucher to used.

Meanwhile, upon receipt of the delivery destination information, the first server 110 transmits the delivery destination information to the second server 120 (S207). Then the second server 120 transmits a delivery command to a terminal of a carrier and the carrier transmits the product to the delivery destination (S208).

While not shown in FIG. 2, the first server 110 performs a payment process with the second server 120, after the delivery or payment is made completely for the product.

Meanwhile, upon receipt of a refund request including the authentication code of the e-voucher from the user terminal 140 of the e-voucher recipient, the first server 110 authenticates the e-voucher based on the state information about the e-voucher. If the e-voucher turns out to be valid, the first server 110 refunds the e-voucher in the form of virtual money and stores the virtual money to a virtual money storage of an account that was opened when the e-voucher recipient subscribed to the online sales service.

Meanwhile, the e-voucher recipient may request refund to the e-tailer after signing up for shipping. In this case, upon receipt of a refund request including the authentication code of the e-voucher from the second server 120, the first server 110 authenticates the e-voucher based on the state information about the e-voucher. If the e-voucher turns out to be valid, the first server 110 refunds the e-voucher in the form of virtual money and stores the virtual money to the virtual money storage of the account that was opened when the e-voucher recipient subscribed to the online sales service and then updates the state information about the e-voucher.

If the purchaser requests refund of the purchase before the recipient of the e-voucher 500 receives the product or exchanges the e-voucher for another product or virtual money, the virtual money may be deposited in the above manner.

More specifically, the purchaser that has purchased a product in the online sales service according to the embodiment of the present invention can monitor use or non-use of the e-voucher 500 in real time. If the e-voucher 500 has not been used yet, the purchaser can cancel or re-send the e-voucher 500.

Particularly, when confirming that the designated recipient has not received the issued e-voucher 500, the purchaser may re-send the e-voucher 500 to the recipient within a predetermined number of times.

In addition, the first server 110 compares a current time with the valid duration of the transmitted e-voucher using the state information about the e-voucher. If the e-voucher has been expired, the first server 110 stores virtual money corresponding to the e-voucher to the virtual money storage of the account opened when the purchaser subscribed to the online sales service and updates the state information about the e-voucher. Owing to the refund of the expired e-voucher, the unused e-voucher-caused loss of the purchaser can be minimized.

Virtual money deposited in the above-described manner may be paid for another product item.

In the method for selling goods online in affiliation with an e-tailer according to the embodiment of the present invention, unauthorized use of an e-voucher is basically impossible because the e-voucher is provided, used, and refunded only after real-time authentication.

Meanwhile, the e-voucher may include a refuse menu by which the e-voucher recipient can refuse to accept the e-voucher. When the e-voucher recipient refuse to accept the e-voucher in the refuse menu on the user terminal 140, the user terminal 140 transmits a refusal signal to the first server 110 and the first user 110 refunds the refused e-voucher to the purchaser in the form of virtual money and stores the virtual money to the virtual money storage of the account that the purchaser opened at the time of subscription to the online sales service.

A method for selling goods online in affiliation with an e-tailer according to an alternative embodiment of the present invention will be described below.

### Embodiment 2

An online sales system for implementing an alternative embodiment of the present invention has the same configuration as illustrated in FIG. 1 and thus its detailed description will not be provided herein. In addition, the alternative embodiment will be described, focusing on the difference from the embodiment of the present invention illustrated in FIG. 2.

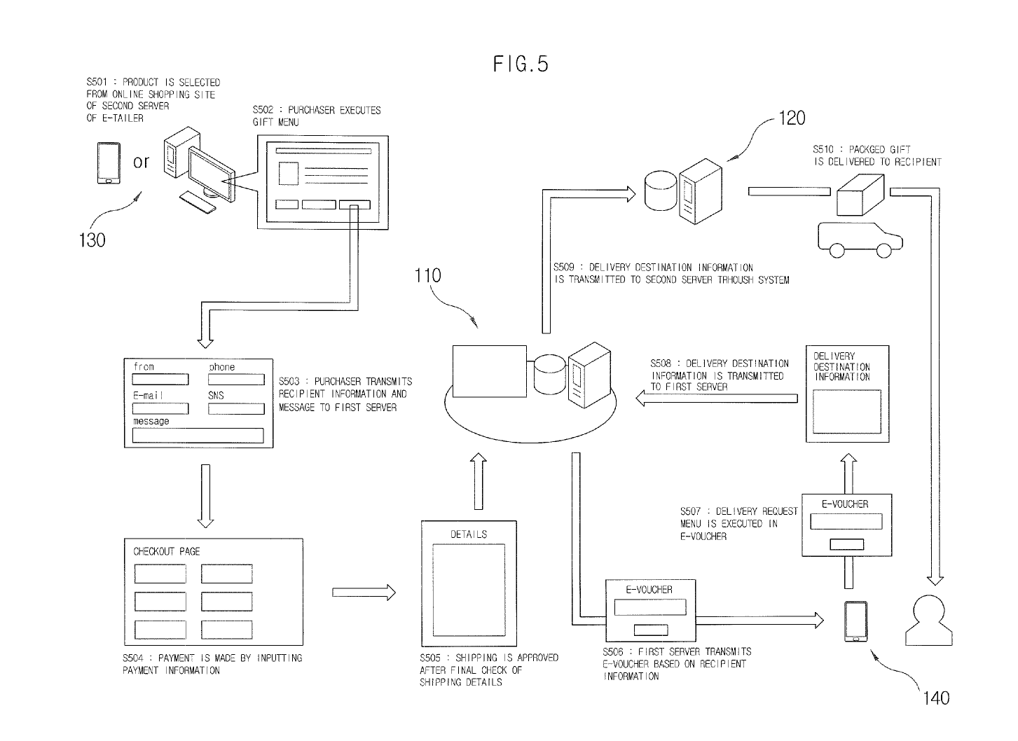

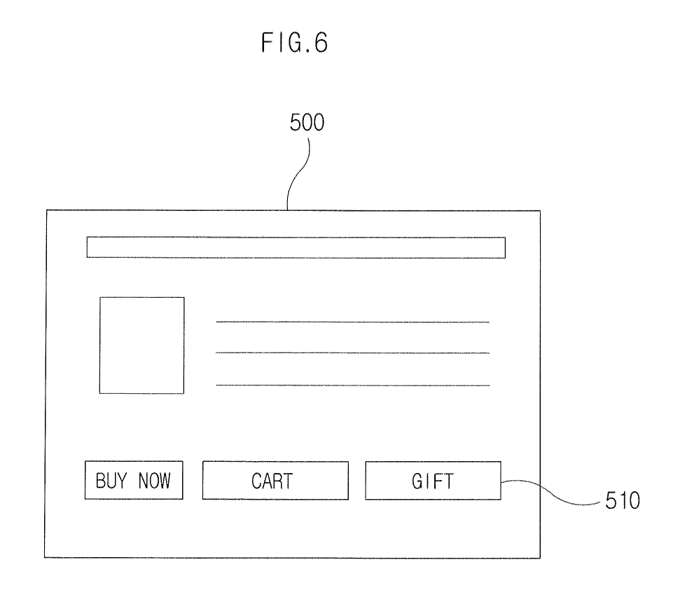

FIG. 5 is a flowchart illustrating a method for selling goods online in affiliation with an e-tailer according to an alternative embodiment of the present invention and FIG. 6 illustrates an exemplary online shopping site run by a second server in the method for selling goods online in affiliation with an e-tailer according to the alternative embodiment of the present invention.

Referring to FIG. 5, when the purchaser accesses the online shopping site of the second server 120 of the e-tailer through the user terminal 130 and selects a desired product from the online shopping site of the second server 120 (S501), a page 500 containing details of the selected product is displayed on the user terminal 130 as illustrated in FIG. 6. A Gift menu 510 is displayed on the page 500. If the purchaser executes the Gift menu 510 through the user terminal 130 (S502), the first server 110 requests e-voucher recipient information and a message to be added to the gift to the purchaser. When the Gift menu 510 is selected, the second server 120 notifies the first server 110 of the product that the purchaser is to buy by transmitting product information to the first server 110.

When the purchaser inputs the e-voucher recipient information and the message, the e-voucher recipient information and the message are transmitted to the first server 110 (S503). The e-voucher recipient information may include at least one of the phone number of the user terminal 140 of the e-voucher recipient, an e-mail address the e-voucher recipient, and an SNS ID of the e-voucher recipient.

Subsequently, the first server 110 requests the user terminal 130 of the purchaser to make payment. When the purchaser inputs payment information, the user terminal 130 transmits the payment information to the first server 110 and the first server processes payment based on the payment information (S504).

The first server 110 requests final confirmation of shipping of an e-voucher to the user terminal 130 of the purchaser. Upon receipt of an approval signal from the user terminal 130 (S505), the first server 110 transmits an e-voucher to the e-voucher recipient (S506).

Meanwhile, the e-voucher recipient views the e-voucher on the user terminal 140 and executes a delivery request menu in the e-voucher (S507). When the e-voucher recipient inputs delivery destination information, the user terminal 140 transmits the delivery destination information to the first server 110 (S508).

The first server 110 transmits the delivery destination information to the second server 120 (S509). Then the second server 120 transmits a delivery command to a terminal of a carrier and the carrier delivers a product corresponding to the e-voucher to the delivery destination (S510).

On the other hand, the e-voucher recipient may request delivery by accessing the online shopping site of the e-tailer in the following manner.

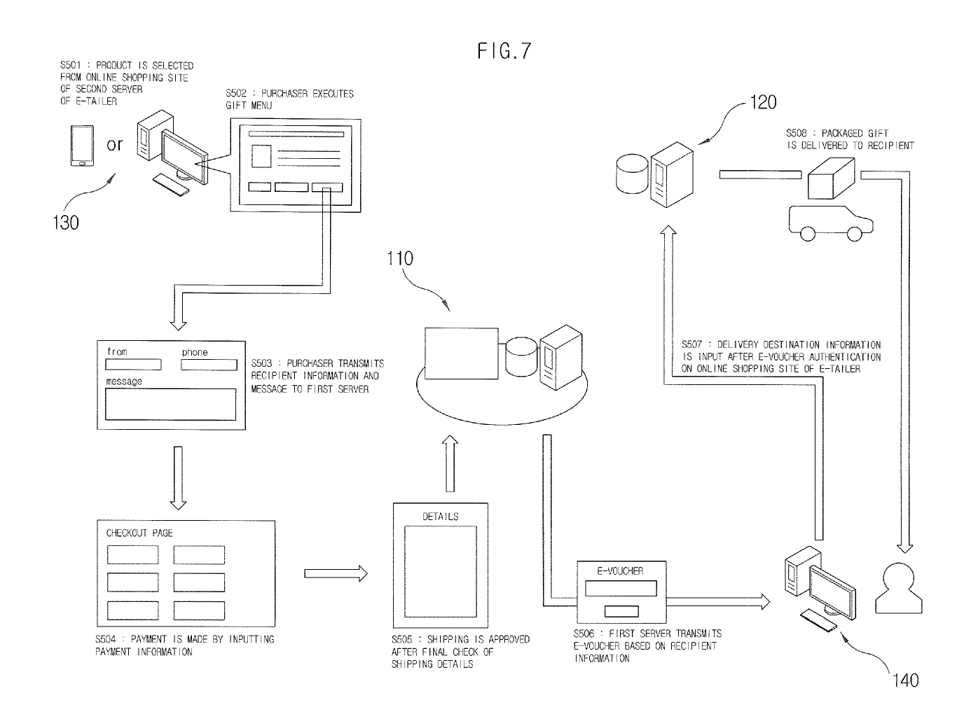

FIG. 7 is another flowchart illustrating the method for selling goods online in affiliation with an e-tailer according to the alternative embodiment of the present invention. Steps 501 to 506 are commonly performed in the procedures illustrated in FIGS. 5 and 7 and thus they will not be described redundantly.

The e-voucher recipient may access the online shopping site of the e-tailer through the user terminal 140, for example, a PC and request delivery of the product by transmitting delivery destination information after authentication of the e-voucher (S507). The e-voucher may be authenticated by inputting an authentication code such as the barcode digits of the e-voucher.

Upon receipt of the delivery destination information, the second server 120 transmits a delivery command to the terminal of the carrier and the carrier delivers the product to the delivery destination (S508).

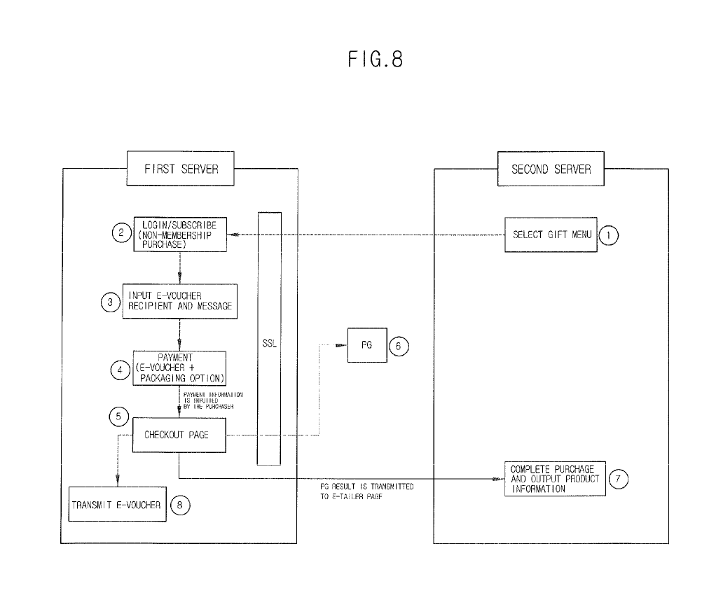

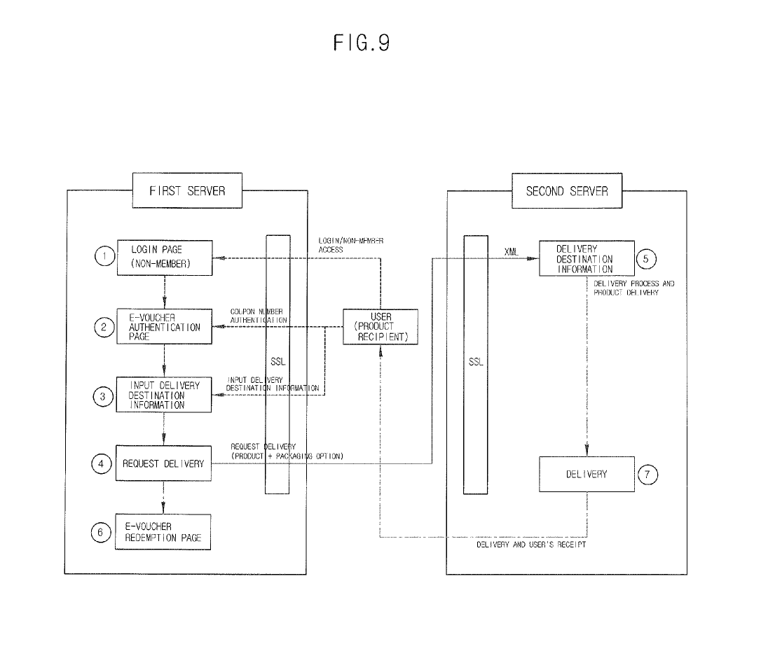

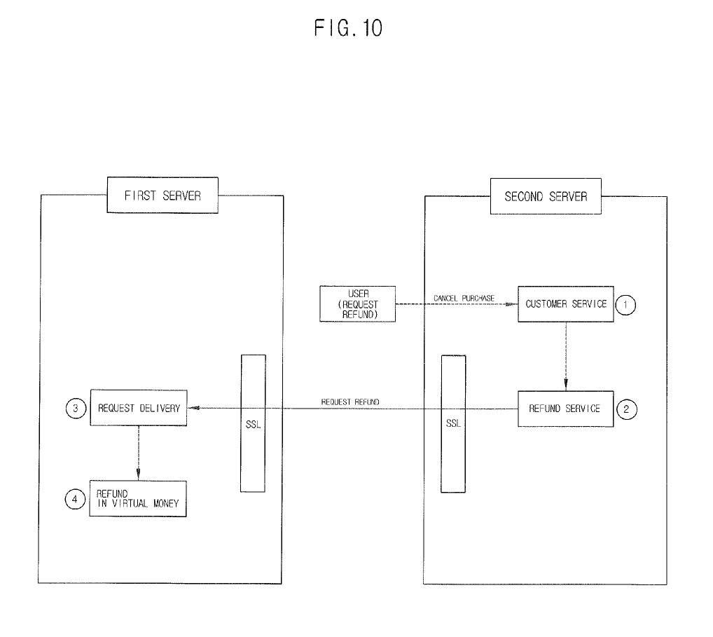

FIG. 8 illustrates a procedure from clicking on a “Gift” button to shipping of an e-voucher in the method for selling goods online in affiliation with an e-tailer according to the alternative embodiment of the present invention, FIG. 9 illustrates a procedure from a purchaser's login to a recipient's receipt of a product in the method for selling goods online in affiliation with an e-tailer according to the alternative embodiment of the present invention, and FIG. 10 illustrates a refund procedure in the method for selling goods online in affiliation with an e-tailer according to the alternative embodiment of the present invention.

The alternative embodiment of the present invention will be described in greater detail with reference to FIGS. 8, 9 and 10.

When the purchaser accesses the online shopping site of the second server 120 and clicks on a “Gift” button, the purchaser is linked to the online shopping site of the first server 110. If the purchaser is a member of the online shopping site of the first server 110, the purchaser may buy a product after log-in. If the purchaser is not a member of the online shopping site of the first server 110, the purchaser may buy a product after a predetermined procedure for non-membership.

After making the purchase, the purchaser inputs information about an e-voucher recipient. The purchaser may also add a message to be sent to the e-voucher recipient.

Payment may be made for the purchase through the first server 110 and a Payment Gate (PG).

Upon completion of the purchase in the above-described predetermined procedure, an e-voucher is transmitted and the result of the purchase is transmitted from the first server 110 to the second server 120.

Then the e-voucher recipient may receive a product or service in the procedure of FIG. 9.

If the e-voucher recipient is a member of the online shopping site of the first server 110, the e-voucher recipient may access the online shopping site of the first server 110 after log-in, to receive a product. On the other hand, if the e-voucher recipient is a not member of the online shopping site of the first server 110, the e-voucher recipient may access the online shopping site of the first server 110 in a predetermined procedure, to receive a product.

After authentication of the e-voucher in the online shopping site of the first server 110, the e-voucher recipient may request delivery by inputting delivery destination information, when needed. The first server 110 transmits the delivery destination information in relation to the delivery request to the second server 120.

Upon receipt of the delivery destination information, the second server 120 transmits a delivery command to a carrier. Then the carrier delivers the product.

Meanwhile, if the recipient that has received the product wants to get the product refunded, the refund may be given in the procedure of FIG. 10. That is, the recipient requests a refund of the product by Customer Service of the product seller and the product seller refunds the product to the recipient according to its refund policies. Meanwhile, refund information is transmitted to the first server 110 and the first server 110 refunds the e-voucher to the e-voucher recipient, with virtual money. Herein, when the e-voucher may be refunded, a predetermined refund fee can be charged for the e-voucher recipient.

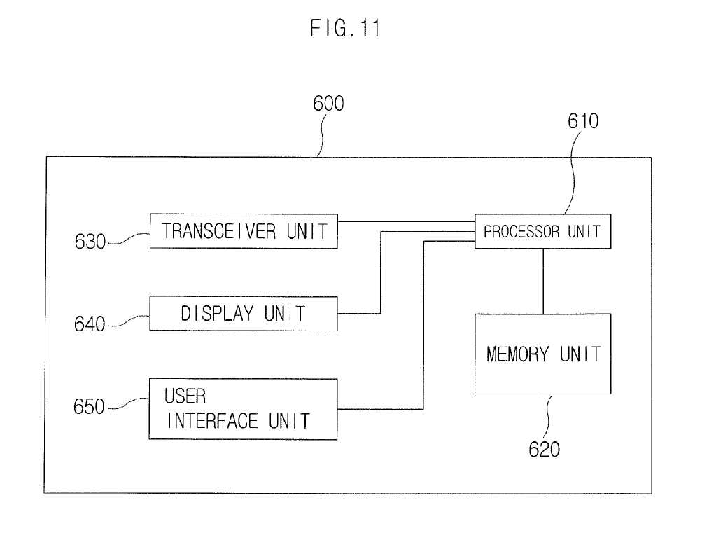

FIG. 11 is a block diagram of a device applicable to the first server and the second server, for implementing the present invention.

Referring to FIG. 11, a device 600 includes a processor unit 610, a memory unit 620, a transceiver unit 630, a display unit 640, and a user interface unit 650. The memory unit 620 is electrically connected to the processor unit 610 and stores an Operating System (OS), applications, and data. The display unit 640 may display various types of information and may be configured with a known display such as a Liquid Crystal Display (LCD), an Organic Light Emitting Diode (OLED), etc. The user interface unit 650 may be configured by combining known user interfaces such as a keypad, a touch screen, etc. The transceiver unit 630 is electrically connected to the processor unit 610 and transmits or receives signals.

As is apparent from the above description of the method and system for selling goods online in affiliation with an e-tailer according to the present invention, the e-tailer can promote sales of products in various sales routes.

Since an e-voucher recipient is allowed to get a product to be delivered to an intended location using a delivery request menu in the e-voucher, the convenience of a product recipient is increased.

In the case where an e-voucher expires before it is used, the e-voucher is redeemed for virtual money and the virtual money is deposited for a product purchaser. Therefore, the unused e-voucher-incurred loss of the product purchaser can be minimized.

If the e-voucher recipient requests refund, the e-voucher is refunded in virtual money and the virtual money is deposited for the e-voucher recipient. As the product recipient's intention is respected in this manner, the satisfaction of the product recipient is increased.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

What is claimed is:

1. A method for selling goods online in affiliation with an e-tailer, comprising:
receiving product information from a second server of the e-tailer by a first server that operates an online sales service;
updating a site for providing the online sales service using the received product information by the first server;
receiving information about a product selected from the site and information about an e-voucher recipient from a terminal of a purchaser by the first server;
requesting payment information to the terminal of the purchaser and receiving the payment information from the terminal of the purchaser by the first server; and
transmitting an e-voucher including an authentication code to a terminal of the e-voucher recipient using the information about the e-voucher recipient by the first server, upon completion of payment based on the payment information, the authentication code being used for exchanging the e-voucher for the selected product.

2. The method according to claim 1, wherein the information about the e-voucher recipient includes at least one of a phone number, an e-mail address, or a Social Networking Service (SNS) IDentifier (ID) of the e-voucher recipient.

3. The method according to claim 1, wherein when the information about the e-voucher recipient includes a phone number of the terminal of the e-voucher recipient, an application for the online sales service is installed on the terminal of the e-voucher recipient, and the e-voucher recipient has subscribed to the online sales service, the e-voucher transmitted by the first server is provided to the e-voucher recipient through the application.

4. The method according to claim 1, wherein the e-voucher includes a delivery request menu for inputting delivery destination information for use in delivery of the selected product.

5. The method according to claim 4, further comprising:
receiving delivery destination information inputted through the delivery request menu from the terminal of the e-voucher recipient by the first server; and
transmitting the delivery destination information to the second server by the first server.

6. The method according to claim 1, further comprising storing state information about the e-voucher by the first server.

7. The method according to claim 6, wherein the state information about the e-voucher includes product information, authentication code information, used or unused indication information, refund information, and valid duration information about the e-voucher.

8. The method according to claim 6, further comprising
authenticating the e-voucher based on the state information about the e-voucher by the first server upon receipt of an authentication request signal including the authentication code of the e-voucher from an offline store terminal,
transmitting an authentication result to the offline store terminal by the first server, and
updating the state information about the e-voucher with the authentication result by the first server.

9. The method according to claim 6, further comprising
comparing a current time with a valid duration of the e-voucher using the state information about the e-voucher by the first server,
storing virtual money corresponding to the e-voucher to a virtual money storage of an account opened when the purchaser subscribed to the online sales service by the first server, when determining that the e-voucher has expired, and
updating the state information about the e-voucher.

10. The method according to claim 6, further comprising
authenticating the e-voucher based on the state information about the e-voucher by the first server upon receipt of a refund request including the authentication code of the e-voucher from the terminal of the e-voucher recipient,
storing virtual money corresponding to the e-voucher to a virtual money storage of an account opened when the purchaser subscribed to the online sales service by the first server, when determining that the e-voucher is valid, and
updating the state information about the e-voucher.

11. A method for selling goods online in affiliation with an e-tailer, comprising:
requesting information about an e-voucher recipient to a terminal of a purchaser by a first server that operates an online sales service, when the terminal of the purchaser executes a gift menu linked to an online shopping site of a second server of the e-tailer;
receiving the information about the e-voucher recipient from the terminal of the purchaser by the first server;
requesting payment information to the terminal of the purchaser and receiving the payment information from the terminal of the purchaser by the first server; and
transmitting an e-voucher including an authentication code to a terminal of the e-voucher recipient using the information about the e-voucher recipient by the first server, upon completion of payment based on the payment information, the authentication code being used for exchanging the e-voucher for the selected product.

12. The method according to claim 11, wherein the information about the e-voucher recipient includes at least one of a phone number, an e-mail address, or a Social Networking Service (SNS) IDentifier (ID) of the e-voucher recipient.

13. The method according to claim 11, wherein when the information about the e-voucher recipient includes a phone number of the terminal of the e-voucher recipient, an application for the online sales service is installed on the terminal of the e-voucher recipient, and the e-voucher recipient has subscribed to the online sales service, the e-voucher transmitted by the first server is provided to the e-voucher recipient through the application.

14. The method according to claim 11, wherein the e-voucher includes a delivery request menu for inputting delivery destination information for use in delivery of the selected product.

15. The method according to claim 14, further comprising:
receiving delivery destination information inputted through the delivery request menu from the terminal of the e-voucher recipient by the first server; and
transmitting the delivery destination information to the second server by the first server.

16. The method according to claim 11, further comprising storing state information about the e-voucher by the first server.

17. The method according to claim 16, wherein the state information about the e-voucher includes product information, authentication code information, used or unused indication information, refund information, and valid duration information about the e-voucher.

18. The method according to claim 16, further comprising
authenticating the e-voucher based on the state information about the e-voucher by the first server upon receipt of an authentication request signal including the authentication code of the e-voucher from an offline store terminal,
transmitting an authentication result to the offline store terminal by the first server, and
updating the state information about the e-voucher with the authentication result by the first server.

19. The method according to claim 16, further comprising
comparing a current time with a valid duration of the e-voucher using the state information about the e-voucher by the first server,
storing virtual money corresponding to the e-voucher to a virtual money storage of an account opened when the purchaser subscribed to the online sales service by the first server, when determining that the e-voucher has expired, and
updating the state information about the e-voucher.

20. The method according to claim 16, further comprising
authenticating the e-voucher based on the state information about the e-voucher by the first server upon receipt of a refund request including the authentication code of the e-voucher from the terminal of the e-voucher recipient,
storing virtual money corresponding to the e-voucher to a virtual money storage of an account opened when the purchaser subscribed to the online sales service by the first server, when determining that the e-voucher is valid, and
updating the state information about the e-voucher.
